(19) United States
(12) Patent Application Publication
(10) Pub. No.: US 2007/0245117 A1
(43) Pub. Date: Oct. 18, 2007

(54) Processor comprising an instruction set and registers for simplified opcode access

(75) Inventor: Christian Hildner, Cadolzburg (DE)

Correspondence Address: BROWDY AND NEIMARK, P.L.L.C.;624 NINTH STREET, NW, SUITE 300, WASHINGTON, DC, 20001-5303, US

(73) Assignee: HOB GmbH & Co. KG, Cadolzburg (DE)

(21) Appl. No.: 11/401,856

(22) Filed: Apr. 12, 2006

(51) Int. Cl. G06F 12/00

(52) U.S. Cl. 711/207

(57) ABSTRACT

A processor including an instruction set and registers is adapted to run a virtual machine monitor software (VMM) for hosting multiple guest operating systems, implementing an instruction translation lookaside buffer ITLB with ITLB-entries and a data translation lookaside buffer DTLB with DTLB-entries. The instruction set comprises advance instructions providing for a translation of a virtual address to a physical address based exclusively on ITLB-entries and a load instruction using the instruction translation lookaside buffer ITLB for a translation of an address of a faulting guest instruction. Furtheron, the processor includes advanced interruption control registers storing the physical address of a faulting guest instruction, an instruction bundle interruption control register storing an instruction bundle of a faulting guest instruction and/or an opcode interruption control register storing an opcode of a faulting guest instruction.

### BACKGROUND OF THE INVENTION

Field of the Invention

The present invention relates to a processor comprising an instruction set and registers and which is adapted to run a virtual machine monitor software (VMM) for hosting multiple guest operating systems, implementing an instruction translation lookaside buffer (ITLB) with ITLB-entries and a data translation lookaside buffer (DTLB) with DTLB-entries.

Virtual machine monitor (VMM) software that is able to run multiple guest operating systems concurrently commonly does emulation of privileged instructions to let a guest operating system think it would run on the original hardware environment. The VMM has to deal with many processor (CPU) specification/implementation details. One common problem arises from the fact that all modern CPUs have separated optimized memory access path for the instruction fetch read operation and data read/write access. The separation involves also separated memory management units (MMUs) for virtual addressing.

The problem now is that the VMM in general does not have the possibility to access the opcode of a faulting instruction in a straightforward way since the virtual address of the faulting instruction is mapped by an instruction translation lookaside buffer (ITLB) whereas the VMM would need the address to be mapped by a data translation lookaside buffer (DTLB) entry since the VMM has to get the instructions opcode with a load instruction that uses the data memory path.

To visualize aforesaid problem reference is drawn to appending FIG. 1 which is a rough diagram of a processor (CPU) 1, to which a memory 2 is associated. The processor 1 implements an instruction translation lookaside buffer ITLB and a data translation lookaside buffer DTLB. Typically the virtual address of an instruction is mapped in the ITLB and so it can be used by the instruction fetch mechanism while attempting to execute the instruction (see arrow 4 in FIG. 1). Now the virtual address of a faulting instruction of one of the guest operating systems OS running under control of the virtual machine monitor VMM is mapped in the ITLB, whereas the VMM normally takes the address for loading an instruction bundle containing the opcode using the DTLB (see dashed arrow 3 in FIG. 1). Inasmuch it is not possible for the VMM to load the instruction bundle by simply performing a load against the address in question because of the missing DTLB entry.

In known processor types as a rule any VMM can bypass the problem by resolving the faulting guest virtual address with the steps shown in FIG. 2.

This flow diagram visualizes the steps necessary to handle above problem to get the opcode of a faulting instruction coming up in a guest operating system. Starting from the virtual address of said instruction in step 10 the according entry in the virtualized ITLB is searched. By this the guest physical address of the instruction is provided for. In step 20 this guest physical address is translated into the host physical address. With this host physical address of the instruction the instruction bundle is loaded from the memory using physical addressing mode in step 30. The instruction bundle includes the information about the opcode of the instruction, which is extracted from the instruction bundle in step 40.

Finally, this opcode is analyzed and the according instruction is emulated by the VMM in step 50.

As an example in the Intel IA-64 architecture a corresponding (simplified) code fragment is listed in the following Table 1:

TABLE 1

| mov r1=cr.iip | // get the virtual address of the instruction |
|---|---|
| | into r1 |

;;

| SEARCH_ITLB(r1,r2) | // routine that searches the corresponding |
|---|---|
| | virt. ITLB |
| ;; | // (r2 now holds the guest physical address of |

the instr.)

| GUEST_TO_HOST(r2,r3) | // routine to translate guest physical address |
|---|---|
| | into |
| | // host physical address |
| | // (r3 now holds the host physical address of |

the instr.)

| rsm psr.dt | // use physical addressing mode for data |
|---|---|
| | references |

;;

| srlz.d | // ensure the effect from rsm psr.dt |
|---|---|
| ld8 r4=[r3] | // load instruction bundle in physical |
| | addressing mode |
| ;; | // (simplified; r4 now holds the instruction |
| | bundle) |
| ssm psr.dt | // back to virtual addressing mode for data |
| | references |
| extr.u r5=r4,x,y | // extract opcode from instruction bundle |
| ;; | // (r5 now holds the opcode of the instruction |
| | to be |
| | // emulated) |
| srlz.d | // ensure virtual addressing mode |

This code sequence has to be performed once while attempting to emulate an instruction. Since the SEARCH_ITLB routine typically executes a loop to find the corresponding entry inside the virtualized ITLB table and the GUEST_TO_HOST routine typically consists of a multilevel page table lookup the whole code sequence is a rather time consuming task. A reasonable part of the performance overhead that a VMM brings compared to an operating system running “on bare metal” is the result of running through that code sequence every time an instruction is emulated.

### SUMMARY OF THE INVENTION

It is an object of the invention to provide instructions and registers, respectively, with the help of which the performance of the processor is drastically enhanced when handling multiple guest operating systems in a virtualized environment.

The common concept of the according invention is the use of some kind of shortcuts to the above showed code sequence with the effect of reducing the time needed to perform the necessary steps.

In a first aspect of the invention above object is met by a processor wherein the instruction set comprises an instruction providing for translation of a virtual address to a physical address based exclusively on ITLB-entries. To assure that these ITLB-entries are consistent the processor prohibits a flushing of the ITLB-entries in case of a program interrupt. By this instruction handling the loading of the opcode can be realized in the physical mode.

According to a second aspect of the invention a processor is provided in which the registers comprise a separate physical address interruption control register storing the physical address of a faulting guest instruction. Due to this additional control register the loading of the opcode could be realized in the physical mode without the need to have a translation from the guest physical address to the host physical address.

According to a third aspect of the invention the instruction set of a processor comprises a load instruction using the instruction translation lookaside buffer ITLB rather than the DTLB for a translation of an address of a faulting guest instruction. This means that the load of the instruction bundle 3 indicated in FIG. 1 would use the ITLB therefore utilizing the identical access path that was originally used for the instruction fetch, guaranteeing a successful load of the correct instruction bundle from the memory 2.

According to a fourth aspect of the invention the registers of the processor comprise at least one instruction bundle interruption control register storing an instruction bundle of a faulting guest instruction. It is an advantage of this embodiment of the invention that the opcode can be extracted directly from the instruction bundle held in the control register.

Finally, in another aspect of the invention the registers of the processor comprise an opcode interruption control register storing directly the opcode of a faulting guest instruction.

### BRIEF DESCRIPTION OF THE DRAWINGS

FIG. 1 shows a sketch of a processor and an associated memory reflecting the problem of accessing the opcode for instruction emulation,

FIG. 2 shows a flow diagram of a typical procedure to get the opcode of a faulting instruction according to the prior art, and

FIG. 3 shows an overall flow diagram reflecting the prior art procedure to get the opcode of a faulting instruction and the alternative procedures based on a processor comprising additional instructions and registers according to the invention.

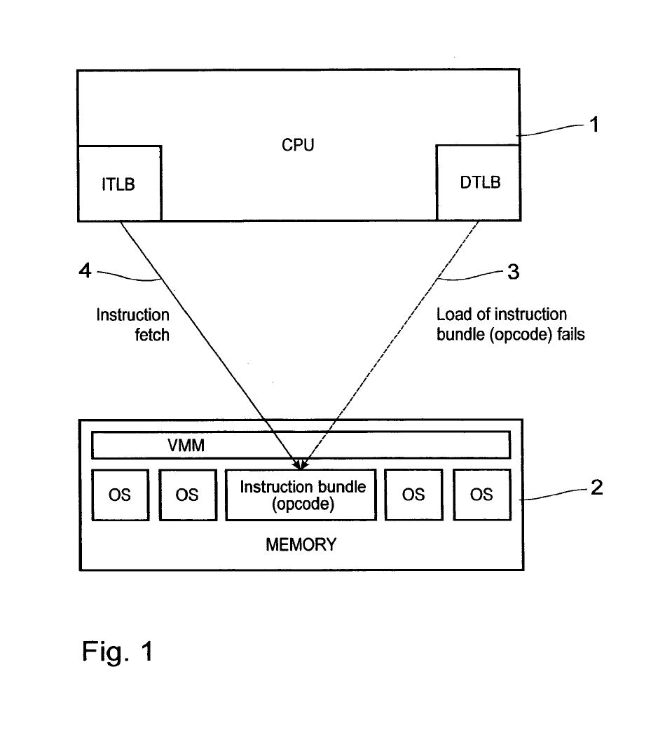

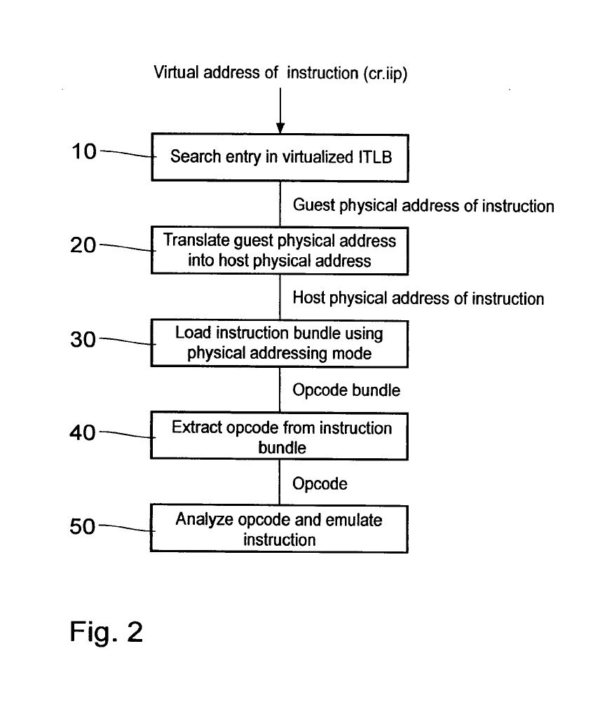

The disclosure of FIGS. 1 and 2 was explained in the introducing part of this application. Attention is drawn to the according passages above.

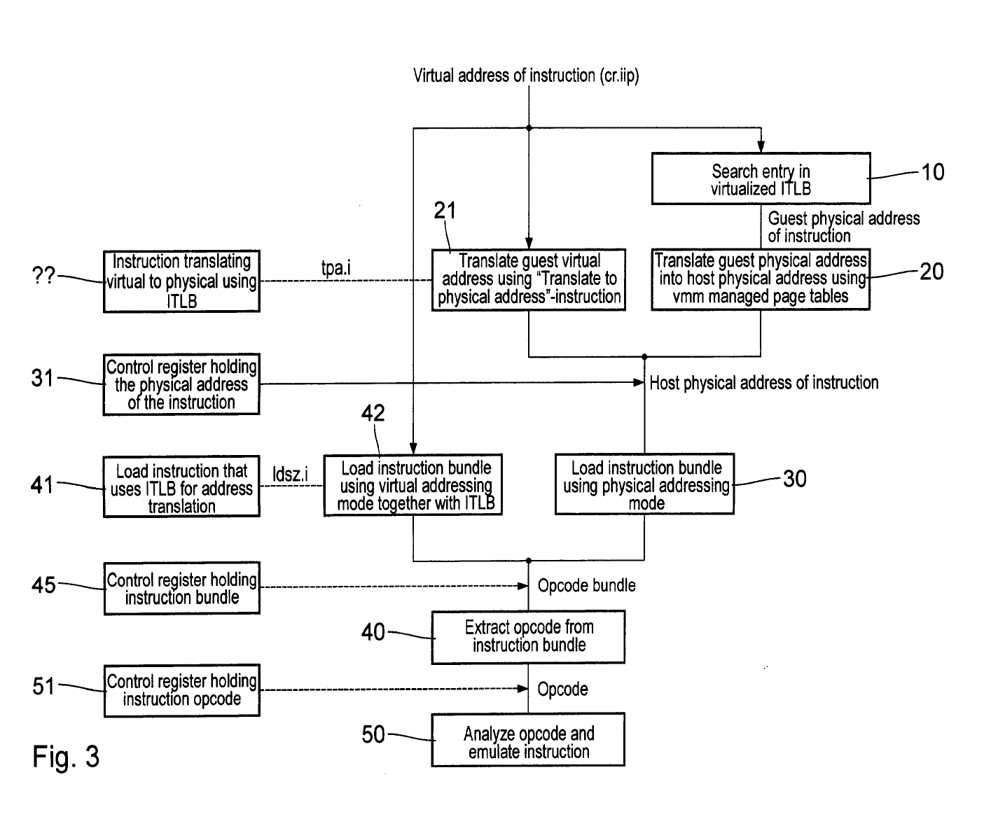

In FIG. 3 the rightmost flow path is identical to the flow path reflected in FIG. 2 and reflects the typical procedure without any aspect of the present invention.

Now using the first aspect of the invention the virtual address of a faulting instruction is handled by the novel instruction which in step 21 provides for a translation of the guest virtual address to the host physical address of the instruction exclusively using ITLB-entries. After that the steps 30, 40 and 50 already explained above are made to get the opcode of the faulting instruction.

A corresponding (simplified) code sequence in the Intel IA-64 architecture is listed in the following Table 2 assuming that above cited novel instruction has the mnemonic tpa.i ra=rb:

TABLE 2

| | |
|---|---|
| mov r1=cr.iip | // get the virtual address of the instruction into r1 |
| ;; | |
| tpa.i r2=r1 | //get the host physical address of the instr. into r2 |
| ;; | |
| rsm psr.dt | // use physical addressing mode for data references |
| ;; | |
| srlz.d | // ensure the effect from rsm psr.dt |
| ld8 r4=[r3] | // load instruction bundle in physical addressing mode |
| ;; | // (simplified; r4 now holds the instruction bundle) |
| ssm psr.dt | // back to virtual addressing mode for data references |
| extr.u r5=r4,x,y | // extract opcode from instruction bundle |
| ;; | // (r5 now holds the opcode of the instruction to be |
| | // emulated) |
| srlz.d | // ensure virtual addressing mode |

As can easily be seen this code sequence got rid of the two (time expensive) routines SEARCH_ITLB and GUEST_TO_HOST and thus avoids a time consuming loop.

According to the second aspect of the invention a interruption control register 31 is provided for storing the physical address of the faulting guest instruction. This means that the translation work of step 21 is avoided and the host physical address of the instruction is achievable from this control register 31.

The (simplified) code sequence in the Intel IA-64 architecture is listed in the following Table 3 assuming that the new control register 31 is named cr.piip:

TABLE 3

| | |
|---|---|
| mov r1=cr.piip | // get the host physical address of the instr. into r1 |
| rsm psr.dt | // use physical addressing mode for data references |
| ;; | |
| srlz.d | // ensure the effect from rsm psr.dt |
| ld8 r4=[r3] | // load instruction bundle in physical addressing mode |
| ;; | // (simplified; r4 now holds the instruction bundle) |
| ssm psr.dt | // back to virtual addressing mode for data references |
| extr.u r5=r4,x,y | // extract opcode from instruction bundle |
| ;; | // (r5 now holds the opcode of the instruction to be |
| | // emulated) |
| srlz.d | // ensure virtual addressing mode |

Again the code sequence is more compact compared to the above examples.

According to the third aspect of the invention the special load instruction ldsz.i is used in step 41 using the instruction translation lookaside buffer ITLB for a translation of a faulting guest instruction. This means that in the flow chart of FIG. 3 in step 42 the instruction bundle is loaded using virtual addressing mode together with the ITLB. From that point on the steps 40 and 50 already explained are taken.

The (simplified) code sequence in the Intel IA-64 architecture of the steps 42, 40, 50 is listed in the following Table 4 assuming that the aforesaid load instruction has the mnemonic ldsz.i ra=[rb]:

TABLE 4

| | |
|---|---|
| mov r1=cr.iip | // get the guest virtual address of the instr. into r1 |
| ;; | |
| ld8.i r2=[r1] | // load instruction bundle in virtual addressing mode |
| ;; | // using ITLB translation information (simplified) |
| extr.u r3=r2,x,y | // extract opcode from instruction bundle |
| | // (r3 now holds the opcode of the instruction to be |
| | // emulated) |

Here an even smaller code fragment compared to the previous tables uses the new load instruction.

According to the fourth aspect of the invention the procedure to get the opcode of a faulting instruction can even be foreshortened by the instruction bundle interruption control register 45 which holds the instruction bundle of a faulting guest instruction including the opcode of the faulting instruction. With the help of this register the opcode can be extracted from the instruction bundle as is depicted in step 40 of FIG. 3. Thereafter the opcode thus provided for can be analyzed and the instruction emulated (step 50).

In the Intel IA-64 architecture the according (simplified) code sequence is listed in the following Table 5 assuming that aforesaid new register 45 is named cr.iib:

TABLE 5

| | |
|---|---|
| mov r1=cr.iib | // get the faulting instruction bundle into r1 |
| ;; | // (simplified) |
| extr.u r2=r1,x,y | // extract opcode from instruction bundle |
| | // (r2 now holds the opcode of the instruction to be |
| | // emulated) |

This code now is near to the theoretic optimum and can be executed in very few cycles.

According to the last aspect of the invention an opcode interruption control register 51 is used to hold the instruction opcode itself. Thus the opcode of a faulting guest instruction can directly be derived from this register 51, analyzed and the according instruction emulated (step 50).

The code sequence in the Intel IA-64 architecture then is extremely short as can be seen from the following Table 6 (the new register 51 is named cr.iop):

TABLE 6

| | |
|---|---|
| mov r1=cr.iop | // get the opcode from instruction bundle |
| | // (r1 now holds the opcode of the instruction to be |
| | // emulated) |

This code is apparently the optimum as it consists of only one instruction left.

What is claimed is:

1. A processor comprising an instruction set and registers, which processor is adapted to run a virtual machine monitor software (VMM) for hosting multiple guest operating systems, implementing an instruction translation lookaside buffer (ITLB) with ITLB-entries and a data translation lookaside buffer (DTLB) with DTLB-entries, wherein the instruction set comprises an instruction (tpa.i) providing for translation of a virtual address to a physical address based exclusively on ITLB-entries.

2. A processor according to claim 1, prohibiting flushing of ITLB-entries in case of a program interrupt.

3. A processor comprising an instruction set and registers, which processor is adapted to run a virtual machine monitor software (VMM) for hosting multiple guest operating systems and running guest instructions, implementing an instruction translation lookaside buffer (ITLB) with ITLB-entries and a data translation lookaside buffer (DTLB) with DTLB-entries, said registers comprise a separate physical address interruption control register (cr.piip) storing the physical address of a faulting guest instruction.

4. A processor comprising an instruction set and registers, which processor is adapted to run a virtual machine monitor software (VMM) for hosting multiple guest operating systems and running guest instructions, implementing an instruction translation lookaside buffer (ITLB) with ITLB-entries and a data translation lookaside buffer (DTLB) with DTLB-entries, wherein the instruction set comprises a load instruction (Idsz.i) using the instruction translation lookaside buffer (ITLB) for virtual address translation.

5. A processor comprising an instruction set and registers, which processor is adapted to run a virtual machine monitor software (VMM) for hosting multiple guest operating systems and running guest instructions, implementing an instruction translation lookaside buffer (ITLB) with ITLB-entries and a data translation lookaside buffer (DTLB) with DTLB-entries, said registers comprise at least one instruction bundle interruption control register (cr.ib) storing an instruction bundle of a faulting guest instruction.

6. A processor according to claim 5, wherein said instruction bundle includes the opcode of said faulting guest instruction.

7. A processor comprising an instruction set and registers, which processor is adapted to run a virtual machine monitor software (VMM) for hosting multiple guest operating systems and running guest instructions, implementing an instruction translation lookaside buffer (ITLB) with ITLB-entries and a data translation lookaside buffer (DTLB) with DTLB-entries, said registers comprise an opcode interruption control register (cr.iop) storing an opcode of a faulting guest instruction.
